(19) United States
(12) Patent Application Publication
(10) Pub. No.: US 2015/0381754 A1
(43) Pub. Date: Dec. 31, 2015

(54) UNIFYING CLOUD SERVICES FOR ONLINE SHARING

(71) Applicant: QUALCOMM INCORPORATED, San Diego, CA (US)

(72) Inventors: Colin Zhao, Sunnyvale, CA (US); Itai VONSHAK, Sunnyvale, CA (US); Stephen WINSTON, Sunnyvale, CA (US)

(73) Assignee: QUALCOMM Incorporated, San Diego, CA (US)

(21) Appl. No.: 14/768,557

(22) PCT Filed: Mar. 28, 2013
(86) PCT No.: PCT/US13/34508

§ 371 Date: Aug. 18, 2015

(51) Int. Cl. H04L 29/08; G06F 3/0484

(52) U.S. Cl. CPC H04L 67/2838; H04L 67/06; H04L 67/32; G06F 3/0484

(57) ABSTRACT

Example embodiments relate to unify cloud services for online sharing. In example embodiments, a system use a web service model to detect a user interaction with a web service and obtain, based on the user interaction, cloud service models associated with cloud services. The system may then obtain cloud content metadata from the cloud services using the cloud service models and transmit cloud content from a cloud service to the web service using a portion of the cloud content metadata.

### BACKGROUND

In some scenarios, a user may store content in various cloud services provided via the Internet. For example, the user may upload foes to multiple cloud storage services so that the user may access the files from different computing devices. The users may access the files on the different computing devices by logging into the different cloud services. Typically, if the user wishes to use a file that is stored in a cloud service, the user downloads the file to his local computing device and then accesses the file using local or web-based applications.

### BRIEF DESCRIPTION OF THE DRAWINGS

The following detailed description references the drawings, wherein:

FIG. 1 is a block diagram of an example system for unifying cloud services for online sharing;

FIG. 2 is a block diagram of an example computing device in communication with a web services and cloud services for unifying the cloud services for online sharing;

FIG. 3 is a flowchart of an example method for execution by a computing device for unifying cloud services for online sharing;

FIG. 4 is a flowchart of an example method for execution by a computing device for unifying cloud services for online sharing; and

FIGS. 5A-5B are diagrams of an example user interface of a web application in which a panel including web content has been displayed.

### DETAILED DESCRIPTION

As detailed above, a cloud service enables users to store content at a single location that is accessible from multiple user devices. For example, a cloud storage service may enable a user to upload his files to a cloud repository that is accessible via the Internet from all the user's compatible devices. The user may use multiple cloud services to store his content; however, the different cloud services are not typically configured to communicate directly with each other. To address this issue, the user may manually share content between cloud services by first downloading the content from a cloud service to his local computing device and then reuploading the content to a target cloud service.

Example embodiments disclosed herein unify cloud services for more simplified online sharing. For example, in some embodiments, a system uses a web service model to detect a user interaction with a web service. In response to a user interaction, the system obtains cloud service models for cloud services based on the user interaction and obtain cloud content metadata from the cloud services using the cloud service models. Based on a selection by the user, the system may then transmit cloud content from a cloud service to the web service using a portion of the cloud content metadata.

In this manner, example embodiments disclosed herein simplify the online sharing of cloud content by facilitating the transmission of cloud content from multiple cloud services to a web service. Specifically, by using cloud content models and metadata, cloud content may be transmitted to a web service while the user is unaware of the details of the underlying cloud services.

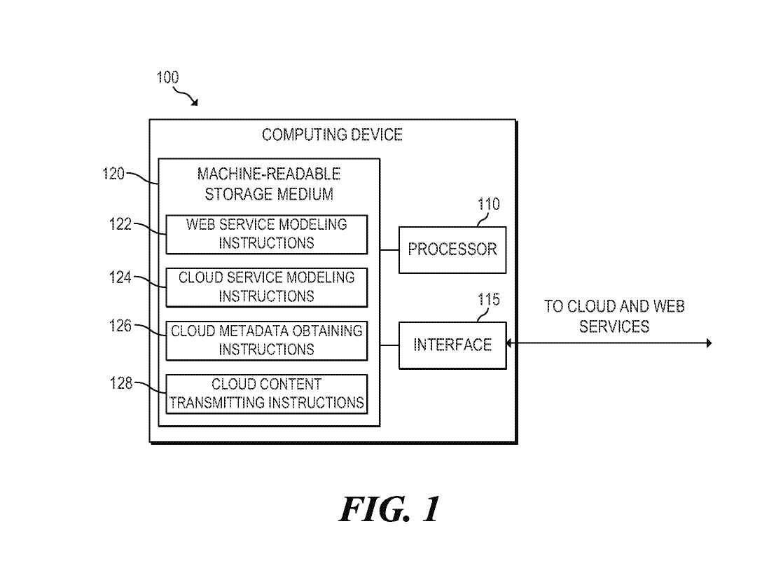

Referring now to the drawings, FIG. 1 is a block diagram of an example system for unifying cloud services for online sharing. The example system can be implemented as, for example, a computing device 100 such as a notebook computer, a desktop computer, an all-in-one system, a tablet computing device, or any other electronic device suitable for unifying cloud services for online sharing. In the embodiment of FIG. 1, computing device 100 includes a processor 110, an interface 115, and a machine-readable storage medium 120,

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable unifying cloud services for online sharing, as described below. As an alternative or in addition to retrieving and executing instructions, processor 110 may include one or more electronic circuits comprising a number of electronic components for performing the functionality of one or more of instructions 122, 124, 126, 128,

Interface 115 may include a number of electronic components for communicating with web service(s) and cloud service(s). For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the web service(s) and cloud service(s). Alternatively, interface 115 may be a wireless interface, such as a wireless local area network (WLAN) interface or a near-field communication (NFC) interface. In operation, as detailed below, interface 115 may be used to send and receive data, such as cloud content, cloud content metadata, and cloud content credentials, to and from a corresponding interface of a web service or a cloud service.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for unifying cloud services for online sharing.

Web service modeling instructions 122 may manage web service models for web services. A web service may be an application or service provided by a web server to client devices over a network. For example, a web application may be executed by a web server to provide web pages to a web browser of computing device 100. In another example, a web service may be executed by a web server to provide functionality in response to requests from computing device 100.

A web service model may describe the possible user interactions and resulting outputs of a corresponding web service. Specifically, a web service model may describe the user inputs (e.g., input textboxes, input buttons, input radial buttons, input drop-downs, submit buttons, etc.) and actions (e.g., navigation to a new web page, execution of a script, etc.) in response to a user submitting a web service. In this case, web service modeling instructions 122 may obtain a web service model that is used to monitor a web service for user interactions. For example, a web service model may allow web service modeling instructions 122 to detect and interrupt a user's interaction with an upload input button. In this example, web service modeling instructions 122 may initiate retrieval of cloud content as described below for populating a list of cloud content for selection by the user.

Cloud service modeling instructions 124 may manage cloud service models for cloud services. A cloud service may provide the use of a computing resource via the Internet. Examples of cloud services include, but are not limited to, a storage service, a database service, a software service, etc. A cloud storage service may allow a user to store files on a cloud server providing the cloud storage service, where the files are remotely accessible to different computing devices of the user.

A cloud service model may describe techniques for interacting with a corresponding cloud service. For example, a cloud service model may describe an advanced programming interface (API) provided by the cloud service. In this example, the API may be used to store and access cloud content (e.g., files, software, database records, etc.) stored in the cloud service. Cloud service modeling instructions 124 may obtain cloud service models based on a user interaction detected by the web service modeling instructions 122. For example, if a user interaction with an upload input button is detected, cloud service models may be retrieved for all the cloud storage services of the user.

Cloud metadata obtaining instructions 126 may obtain cloud metadata for cloud services using cloud service models. Cloud metadata may describe cloud content stored by a corresponding cloud service. For example, cloud metadata may describe the files stored and the directory structure of a cloud storage service. In this example, the cloud metadata may be used to populate a file selection user control with files stored in multiple cloud storage services. Further, the cloud metadata may allow cloud content transmitting instructions 128 to obtain a file from one of the cloud storage services in response to a user selection.

Cloud content transmitting instructions 128 may obtain cloud content from a cloud service and then transmit the cloud content to a web service. Specifically, cloud metadata may be used to obtain cloud content from a cloud service, and then a web service model may be used to transmit the cloud content to a web service. Because preconfigured models are used, the transmission of the cloud content is performed without user interaction other than the selection of the file from the file selection user control.

The cloud services of a user may be preconfigured with computing device 100 for access by cloud metadata obtaining instructions 126 and cloud content transmitting instructions 128. For example, the user may provide cloud content credentials for various cloud services to allow cloud metadata obtaining instructions 126 and cloud content transmitting instructions 128 to access the various cloud services. In another example, a cloud service may allow the user to grant access permission to external applications and services.

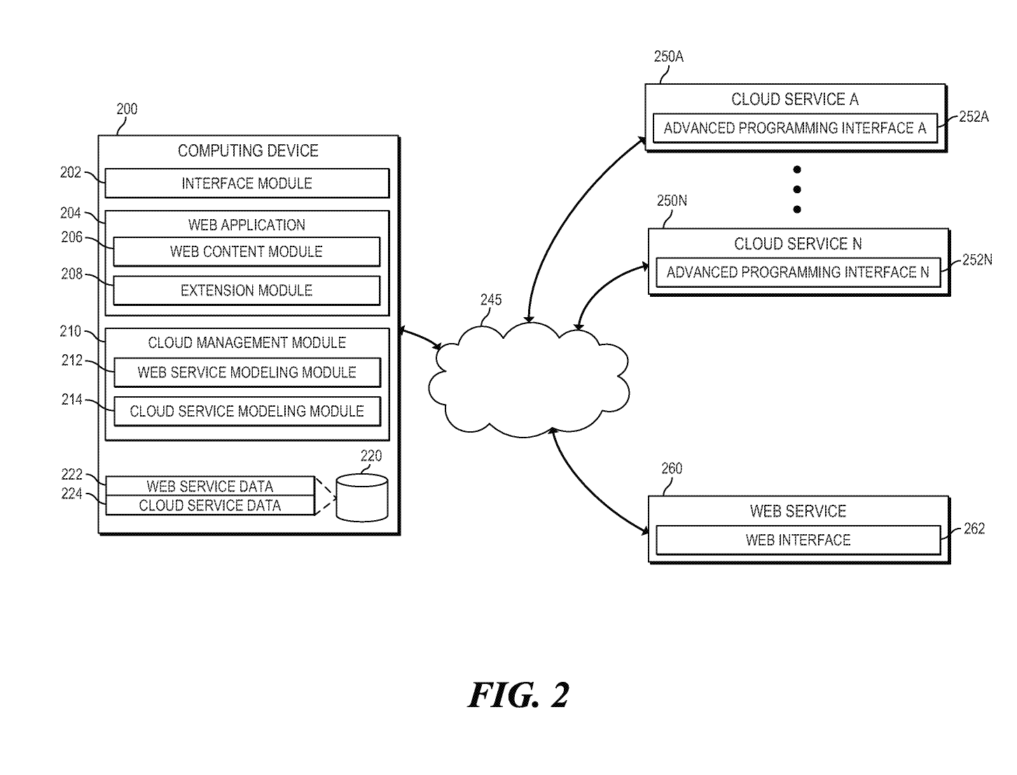

FIG. 2 is a block diagram of an example computing device 200 in communication via a network 245 with cloud services 250A, 250N and web service 262. As illustrated in FIG. 2 and described below, computing device 200 may communicate with cloud services 250A, 250N and web service 260 to unify cloud services for online sharing.

As illustrated, computing device 200 may include a number of modules 202-214. Each of the modules may include a series of instructions encoded on a machine-readable storage medium and executable by a processor of computing device 200. In addition or as an alternative, each module may include one or more hardware devices including electronic circuitry for implementing the functionality described below.

Interface module 202 may manage communications with cloud services 250A, 250N and web service 260. Specifically, the interface module 202 may initiate connections with cloud services 250A, 250N and web service 260 and then send or receive cloud data to cloud services 250A, 250N and web service 260.

Web application 204 may provide a user with access to cloud services 250A, 250N and web service 260. Although the components of web application 204 are described in detail below, additional details regarding an example implementation of web application 204 are provided above in connection with cloud metadata obtaining instructions 126 and cloud content transmitting instructions 128 of FIG. 1.

Web content module 206 may obtain and display web content from web service 260. For example, web content module 206 may obtain web pages from a web server and then display the web pages for the user of computing device 200. The web pages may provide access to services such as, but not limited to, social networking, electronic mail, picture sharing, etc. In another example, web content module 206 may access web service 260 to obtain access to functionality such as software as a service.

Extension module 208 may allow extensions to run within the web application 204. An extension may be third-party functionality that extends the capabilities of the web application 204. In this case, the extension may have access to all web content displayed by the web content module 206. The extension module 208 may use web service models obtained from the web service modeling module 212 to monitor user interactions with web content. For example, extension module 208 may monitor a web page for user selections of input buttons. In this example, if a user selection of an input button is detected, extension module 208 may interrupt the processing of the selection to provide a user control displaying cloud content for selection. The cloud content for selection may be determined using cloud service models from the cloud service modeling module 214.

Extension module 208 may also identify and access cloud content based on cloud metadata obtained from cloud services (e.g., cloud service A 250A, cloud service N 250N) using cloud service models. The cloud service models may describe API's provided by the cloud services, where the API's are used by extension module 208 to obtain the cloud metadata.

Cloud management module 210 may manage the process for managing cloud service models and web service models. Although the components of cloud management module 210 are described in detail below, additional details regarding an example implementation of cloud management module 210 are provided above in connection with web service modeling instructions 122 and cloud service modeling instructions 124 of FIG. 1.

Web service modeling module 212 may manage web service models for web services. For example, a web service model may be manually preconfigured and shared between computing devices (e.g., computing device 200). in another example, a web service model may be generated automatically by using web scraping or for a web service with a self-describing interface. In yet another example, a web service model may be generated in real-time as the web content is accessed by the user. In any of the examples, a web service model may describe the user inputs (e.g., input textboxes, input buttons, input radial buttons, input drop-downs, submit buttons, etc.) and actions (e.g., navigation to a new web page, execution of a script, etc.) resulting from a user submitting a web service, Web service modeling module 212 may store the web service models as web service data 222.

Cloud service modeling module 214 may manage cloud service models for cloud services. For example, a cloud service model may be generated based on an API provided by a corresponding cloud service. In this example, the cloud service model may describe functions of the API that provide access to cloud content managed by the cloud service. A cloud service model may be used to obtain cloud content and corresponding metadata from a cloud service. Cloud service modeling module 214 may store the cloud service models as cloud service data 224.

As shown, computing device 200 may interact with a number of cloud services (e.g., cloud service A 250A, cloud service N 250N). Each of the cloud services (e.g., cloud service A 250A, cloud service N 250N) may manage a different set of cloud content that is accessible to computing device 200. Further, the cloud services (e.g., cloud service A 250A, cloud service N 250N) may manage various types of cloud content including, but not limited to, files, social networking content, software services, etc. Each of the cloud services (e.g., cloud service A 250A, cloud service N 250N) may include an advanced programming interface (API) (e.g., API A 252A, API N 252N). As discussed above, an API (e.g., API A 252A, API N 252N) may provide computing device 200 with access to cloud content managed by a corresponding cloud service (e.g., cloud service A 250A, cloud service N 250N). Each of the cloud services (e.g., cloud service A 250A, cloud service N 250N) may be provided by a server computing device (not shown).

Web service 260 may be an application or service provided by a web server (not shown) to computing device 200 over network 245. For example, web service 260 may be an application that provides a web page to computing device 200. Web service 260 may include a web interface 262 for receiving and processing requests from computing device 200. In this example, web interface 262 may receive user requests generated based on user interactions with the web page, where the web page is dynamically modified in response to the user requests.

Storage device 220 may be any hardware storage device for maintaining data accessible to computing device 200. For example, storage device 220 may include one or more hard disk drives, solid state drives, tape drives, and/or any other storage devices. The storage devices may be located in computing device 200 and/or in another device in communication with computing device 200. As detailed above, storage device 220 may maintain web service data 222 and cloud service data 224.

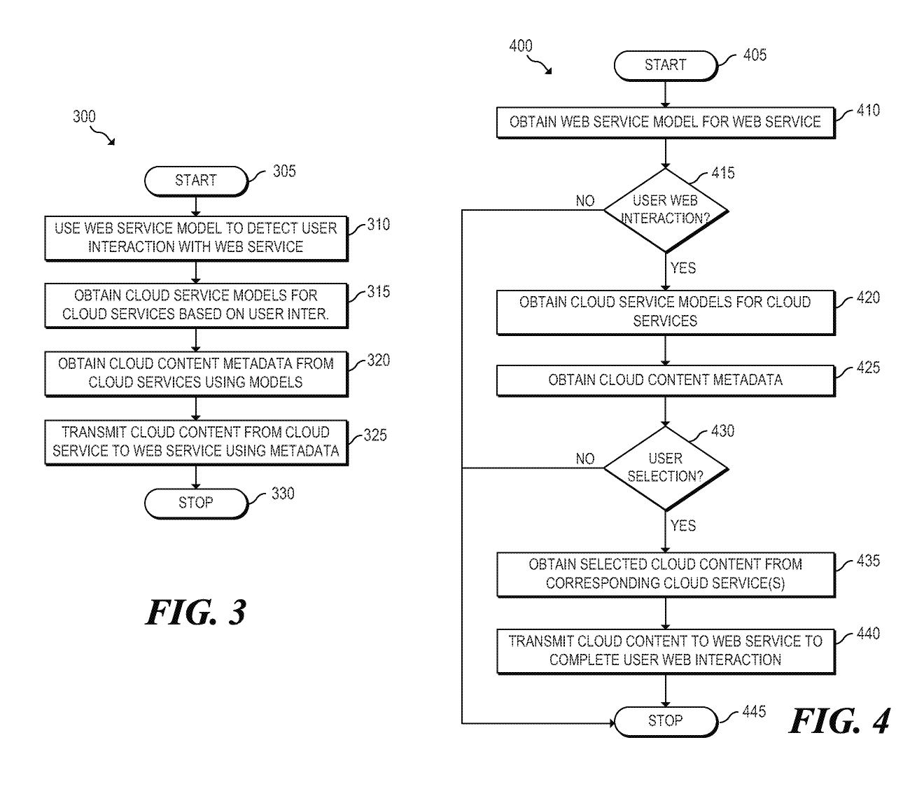

FIG. 3 is a flowchart of an example method 300 for execution by a computing device 100 for unifying cloud services for online sharing. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 may use a web service model to detect a user interaction with a web service. For example, the web service model may describe user inputs (e.g., input buttons, radial buttons, input textboxes, etc.) of a web page provided by the web service. In this example, the detected user interaction may be a user selection of an input button. In response to detecting the user interaction, the processing of the web page may be interrupted so that the steps below may be performed.

In block 315, cloud service models for cloud services are obtained based on the detected user interaction, For example, if the user interaction is a selection of an upload input button, cloud service models may be obtained for all known cloud storage services of the user. The cloud service models may describe the API's for obtaining cloud content metadata and cloud content from the respective cloud services. Next, in block 320, cloud content metadata is obtained from the cloud services using the cloud service models. The cloud content metadata may describe cloud content stored by the cloud services. In this example, the cloud content metadata may include file descriptions, file locations, file sizes, etc, of cloud files stored in the cloud storage services.

In block 325, cloud content may be transmitted from a cloud service to the web service using the cloud service metadata. For example, in response to the user selecting a cloud file from the list of cloud files stored in the cloud storage services, the cloud content metadata may be used to determine the location of the cloud file, download the cloud file to a local buffer on computing device 100, and then upload the cloud file to the web service. Method 300 may then continue to block 330, where method 300 may stop.

FIG. 4 is a flowchart of an example method 400 for execution by a computing device 200 for unifying cloud services for online sharing. Although execution of method 400 is described below with reference to computing device 200 of FIG. 2, other suitable devices for execution of method 400 may be used, such as computing device 100 of FIG. 1. Method 400 may be implemented in the form of executable instructions stored on a machine-readable storage medium and/or in the form of electronic circuitry.

Method 400 may start in block 405 and proceed to block 410, where computing device 200 may obtain a web service model for a web service that is currently being accessed by the user. In block 415, computing device 200 determines if there is a user interaction with the web service. If there is no user interaction, method 400 may stop. If there is a user interaction (e.g., selecting an input button), cloud service models for known cloud services of the user may be obtained based on the user interaction in block 420. The cloud services may manage cloud content that is related to the user interaction detected in block 415. For example, the cloud services may be cloud storage services if the user selected an upload file button. In another example, the cloud services may be cloud social services if the user selected a share button.

In block 425, cloud content metadata is obtained using the cloud service models. The cloud content metadata may describe the cloud content stored in the cloud services for the user. In block 430, computing device 200 determines if the user has selected cloud content from a list of cloud content displayed for the user. The list of cloud content may be generated based on the cloud content metadata. If the user does not make a selection of cloud content, method 400 may stop.

If the user does make a selection of cloud content, computing device 200 obtains the cloud content selected by the user from corresponding cloud service(s) in block 435. In this example, the selected cloud content may be a cloud file stored in a cloud storage service. The obtained cloud content may then be stored in a local buffer of the computing device 200. Next, in block 440, the cloud content may be transmitted to the web service that is currently being accessed by the user to complete the web interaction. For example, a cloud file may be provided to the web service to complete a file upload that was initiated by the selection of an upload file button detected in block 415. Method 400 may subsequently proceed to block 445, where method 400 may stop.

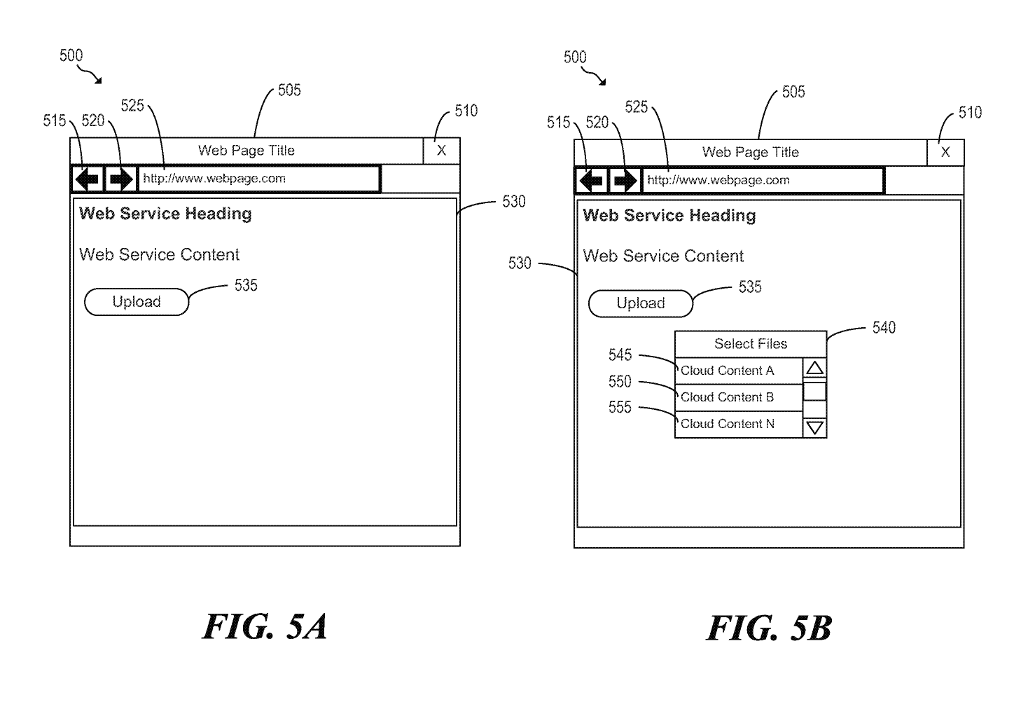

FIGS. 5A-5B are diagrams of example user interface 500 of a web application in which a panel 530 including web content has been displayed. As depicted, the user interface 500 includes a title bar 505 identifying the web content and a close icon 510 that may be used by the user to exit the application. The user interlace 500 also includes navigation components: a back button 515, a forward button 520, and a web address input textbox 525.

The user interface 500 has outputted a web page provided by a web service in the panel 530. In FIG. 5A, an upload file button 535 is shown in the web page. In response to the user selecting the upload file button 535, a select file dialog 540 as shown in FIG. 5B is displayed. The select file dialog 540 lists cloud content (e.g., cloud content A 545, cloud content B 550, cloud content N 555) from multiple cloud services for selection by the user. The select file dialog 540 may be provided by an extension of the web application, where the extension interrupts the user's selection of the upload file button 535 to display the custom select file dialog 540. In some cases, the list of cloud content in the select file dialog 540 may be grouped based on the originating cloud service that manages the cloud content.

The foregoing disclosure describes a number of example embodiments for unifying cloud services for online sharing by a computing device. In this manner, the embodiments disclosed herein enable unifying cloud services for online sharing by using cloud service models to obtain cloud content from multiple cloud services for providing to a web service.

1. A system for unifying cloud services for online sharing, the system comprising:
a processor to:
use a web service model to detect a user interaction with a web service;
obtain, based on the user interaction, a plurality of cloud service models associated with a plurality of cloud services;
obtain cloud content metadata from the plurality of cloud services using the plurality of cloud service models; and
transmit cloud content from a cloud service of the plurality of cloud services to the web service using a portion of the cloud content metadata.

2. The system of claim 1, wherein the web service model describes a plurality of user inputs of the web service.

3. The system of claim 1, wherein each of the plurality of cloud service models describes an advanced programming interface of a corresponding cloud service of the plurality of cloud services.

4. The system of claim 1, wherein the processor is further to:
interrupt the user interaction to display a list of cloud content based on the cloud content metadata, wherein the cloud content is transmitted in response to a user making a selection from the list of cloud content.

5. The system of claim 1, wherein the user interaction is a selection to upload a file to the web service, and wherein the cloud content is a cloud stored file of a plurality of cloud stored files stored by the plurality of cloud services.

6. The system of claim 5, wherein the processor transmits the cloud stored file from the cloud service to the web service by:
obtaining the cloud stored file from the cloud service, wherein the cloud stored file is stored in a local buffer; and
transmitting the cloud stored file from the local buffer to the web service.

7. A method for unifying cloud services for online sharing, the method comprising:
using a web service model to detect a user interaction with a web service, wherein the web service model describes a plurality of user inputs of the web service;
obtaining, based on the user interaction, a plurality of cloud service models associated with a plurality of cloud services;
obtaining cloud content metadata from the plurality of cloud services using the plurality of cloud service models; and
transmitting cloud content from a cloud service of the plurality of cloud services to the web service using a portion of the cloud content metadata.

8. The method of claim 7, wherein each of the plurality of cloud service models describes an advanced programming interface of a corresponding cloud service of the plurality of cloud services.

9. The method of claim 7, further comprising:
interrupting the user interaction to display a list of cloud content based on the cloud content metadata, wherein the cloud content is transmitted in response to a user making a selection from the list of cloud content.

10. The method of claim 7, wherein the user interaction is a selection to upload a file to the web service, and wherein the cloud content is a cloud stored file of a plurality of cloud stored files stored by the plurality of cloud services.

11. The method of claim 10, wherein transmitting the cloud stored file from the cloud service to the web service comprises:
obtaining the cloud stored file from the cloud service, wherein the cloud stored file is stored in a local buffer; and
transmitting the cloud stored file from the local buffer to the web service.

12. A no-transitory machine-readable storage medium encoded with instructions executable by a processor, the machine-readable storage medium comprising:
using a web service model to detect a user interaction with a web service, wherein the web service model describes a plurality of user inputs of the web service;
obtaining, based on the user interaction, a plurality of cloud service models associated with a plurality of cloud services, wherein each of the plurality of cloud service models describes an advanced programming interface of a corresponding cloud service of the plurality of cloud services;
obtaining cloud content metadata from the plurality of cloud services using the plurality of cloud service models; and
transmit cloud content from a cloud service of the plurality of cloud services to the web service using a portion of the cloud content metadata.

13. The machine-readable storage medium of claim 12, further comprising:
interrupting the user interaction to display a list of cloud content based on the cloud content metadata, wherein the cloud content is transmitted in response to a user making a selection from the list of cloud content.

14. The machine-readable storage medium of claim 12, wherein the user interaction is a selection to upload a file to the web service, and wherein the cloud content is a cloud stored file of a plurality of cloud stored files stored by the plurality of cloud services.

15. The machine-readable storage medium of claim 14, wherein transmitting the cloud stored the from the cloud service to the web service comprises:
obtaining the cloud stored file from the cloud service, wherein the cloud stored file is stored in a local buffer; and
transmitting the cloud stored file from the local buffer to the web service.
